(19) United States
(12) Patent Application Publication
(10) Pub. No.: US 2018/0214804 A1
(43) Pub. Date: Aug. 2, 2018

(54) WATER FILTER CARTRIDGE WITH FILTER KEY

(71) Applicant: National Trade Supply, LLC, Greenwood, IN (US)

(72) Inventor: Tyler Dishman, Greenwood, IN (US)

(21) Appl. No.: 15/418,222

(22) Filed: Jan. 27, 2017

(51) Int. Cl. B01D 35/30; C02F 1/00; F25D 23/12

(52) U.S. Cl. CPC B01D 35/30; C02F 1/001; F25D 2323/121; B01D 2201/4092; B01D 2201/4061; F25D 23/126

(57) ABSTRACT

What is provided is a water filter assembly comprising a filter cartridge. The filter cartridge comprises a filter head comprising an inlet port; an outlet port; and a filter key integrally formed on the filter head between the inlet port and the outlet port. The filter key consists of exactly one laterally extending finger that is integrally formed on the filter key. The filter key is integral with the filter head as a one piece construction to form a more water-tight seal on the filter cartridge and help prevent the filter key from being separated from the filter cartridge. The finger may have a substantially polygon-shaped cross-section to more efficiently and quickly interlock the filter key with components on a filter receiver. As a result, the filter cartridge may be readily attached to and removed from the filter, while being securely enough engaged to avoid unwanted uncoupling.

### FIELD

This patent application relates generally to residential and commercial water filters. Specifically, this patent application relates to a water filter having a filter key for easy removal and replacement from a receiver.

### BACKGROUND

Water filters are increasingly prevalent in residential and commercial environments. In addition to improving the taste and appearance of the water, water filters also reduce the risk of undesirable microbial contamination from municipal water sources or underground wells. However, water filters must often be designed so that they are compact and unobtrusive in order to allow for frequent and easy replacement of used filters from receiver devices, such as refrigerators. Refrigerators typically have a water dispenser in fluid communication with a source of water and a filter.

Water filters can be difficult to manually attach to a receiver device since they require the user to precisely align the water filter prior to pushing it into the receiver device. For example, in some water filters, the water filter will not properly attach to the receiver device unless the water filter is pushed far enough for all of the necessary elements on the filter head to extend fully into the receiver device. This is particularly difficult when there are a plurality of elements on the filter head that need to be simultaneously aligned and/or when the receiver device is not properly centered or at a slight angle.

Further, in some water filters, certain components, such as the filter head, may be more prone to becoming detached from the rest of the water filter. As a result, it becomes impossible to install the water filter into the receiver device. During normal operation, some of the water filters may mistakenly (without any user intervention) become disconnected from the refrigerator, which results in leakage and damage to the refrigerator. Thus, a water filter is needed that can be easily attached to and removed from a refrigerator with minimal effort from the user, while also being securely locked to the refrigerator to avoid uncoupling or disconnection of the entire water filter or its components.

### SUMMARY

What is provided is a water filter assembly comprising a filter cartridge. In exemplary embodiments, the filter cartridge comprises a filter housing for enclosing a filter media, and a filter head securely connected to the filter housing, the filter head comprising an inlet port; an outlet port; and a filter key integrally formed on the filter head between the inlet port and the outlet port, the filter key consisting of exactly one finger extending laterally from the top of the filter head, wherein the finger is integrally formed on the filter key and the finger comprises angled sides configured for attachment to a filter receiver.

In exemplary embodiments, the finger has a substantially polygon-shaped cross-section to more efficiently and quickly interlock the filter key with components on the filter receiver. In other embodiments, the finger has a substantially boomerang/stealth-bomber-shaped cross-section, a small substantially circular-shaped cross-section, or a substantially kidney-bean (rounded boomerang) shaped cross-section.

The filter key is integral with the filter head as a one piece construction and, as such, cannot be removed from the filter cartridge. In addition to providing a more water-tight seal on the filter cartridge, the integration of the filter key to the filter head helps prevent the filter key from being separated (and potentially lost) from the filter cartridge either before or during operation.

In exemplary embodiments, the water filter assembly comprises a filter cartridge and a filter receiver. The filter cartridge is secured to the filter receiver in order to filter liquids by intercepting chemical and microbial contaminants. The filter cartridge comprises a filter housing for enclosing a filter media; a filter head securely connected to the filter housing, the filter head comprising an inlet port; an outlet port; and a filter key integrally formed on the filter head between the inlet port and the outlet port, the filter key consisting of one finger extending laterally from the top of the filter head, wherein the finger is integrally formed on the filter key and the finger comprises angled sides. The filter receiver configured for specifically receiving and securely connecting the finger upon insertion of the filter cartridge into the filter receiver, wherein the filter receiver comprises a filter receiver inlet port; a filter receiver outlet port; and a lock.

The subject matter described herein may provide one or more of the following advantages. First, the water filter cartridge can be easily attached and removed from a filter receiver, such as a refrigerator, with minimal effort from the user. Second, the water filter cartridge can be securely engaged with the filter receiver to avoid uncoupling or disconnection of the entire water filter or its components. Third, the water filter cartridge described herein may engage with a number of different models of filter receivers and be used by a number of different water filter models.

The details of one or more implementations are set forth in the accompanying drawings and description below. Other features and advantages will be apparent from the description, the drawings, and the claims.

### BRIEF DESCRIPTION OF THE DRAWINGS

Subject matter is particularly pointed out and distinctly claimed in the concluding portion of the specification. Claimed subject matter, however, as to structure, organization and method of operation, together with objects, features, and advantages thereof, may best be understood by reference to the following detailed description if read with the accompanying drawings in which:

FIG. 1 is an exploded perspective view of an exemplary water filter assembly;

FIG. 2 is a plan view of the filter cartridge shown in FIG. 1;

FIG. 3 is a perspective view of the filter cartridge shown in FIG. 1 with a rib extending down the outer surface of the filter housing;

FIG. 4 is a front perspective view of an exemplary filter head integrated with the filter key;

FIG. 5 is a front view of the filter head integrated with the filter key shown in FIG. 4;

FIG. 6 is a back view of the filter head integrated with the filter key shown in FIG. 4;

FIG. 7 is a top view the filter head integrated with the filter key shown in FIG. 4;

FIG. 8 is a bottom view of the filter head integrated with the filter key shown in FIG. 4;

FIG. 9 is a cross-sectional view of the filter cartridge shown in FIG. 1 engaging with an exemplary filter receiver; and

FIG. 10 is a perspective view of the filter cartridge shown in FIG. 1 engaging with the filter receiver shown in FIG. 9.

### DETAILED DESCRIPTION OF THE INVENTION

In the following detailed description, numerous specific details are set forth in order to provide a thorough understanding of the examples as defined in the claimed subject matter, and as an example of how to make and use the examples described herein. However, it will be understood by those skilled in the art that claimed subject matter is not intended to be limited to such specific details, and may even be practiced without requiring such specific details. In other instances, well-known methods, procedures, and components have not been described in detail so as not to obscure the invention defined by the claimed subject matter.

What is provided is an exemplary water filter assembly shown generally at 100 in the figures. The water filter assembly 100 includes a removable filter cartridge 110 and a filter receiver 120. The filter cartridge 110 is secured to the filter receiver 120 in order to filter liquids by intercepting chemical and microbial contaminants. The description set forth below for the filter receiver 120 is applicable to all types of refrigerator appliances, including but not limited to household refrigerators, and other types of appliances that dispense water or fluid. Some examples include commercial refrigerators, icemakers, filtered water bottlers, freezers, or any other type of appliance that may include a water filtration system. The disclosure is therefore not intended to be limited to any particular refrigeration apparatus or configuration described in the exemplary embodiments of this disclosure.

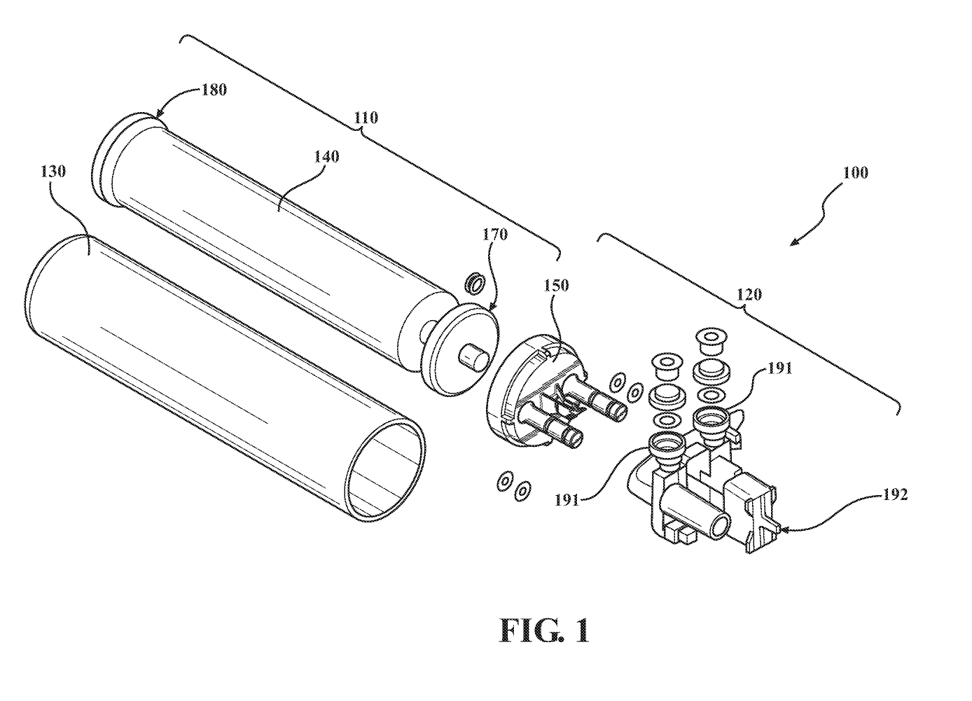

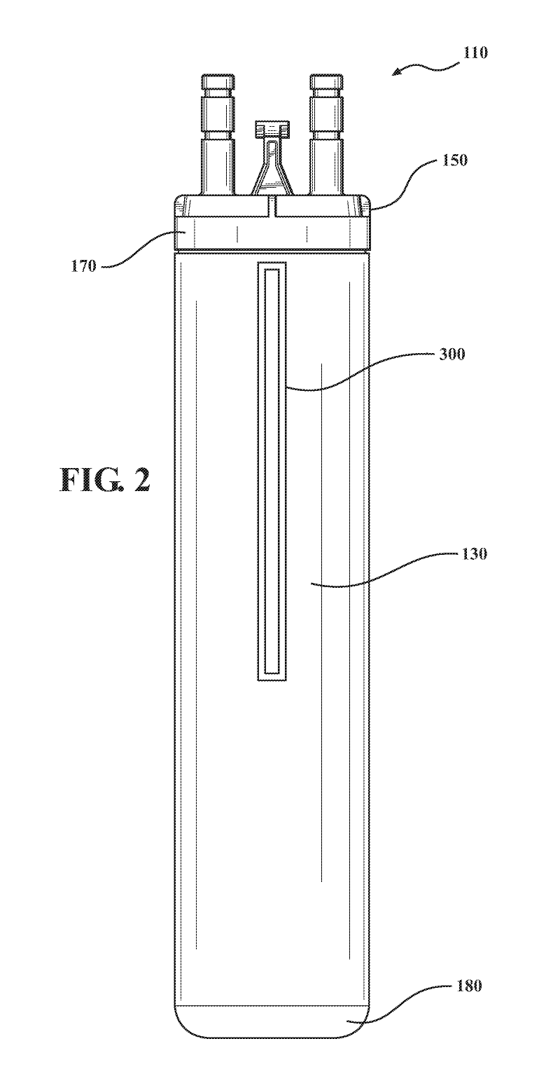

As illustrated in FIGS. 1-3, the filter cartridge 110 comprises a filter housing 130, which encloses a filter media 140, and a filter head 150 that attaches at one end to the filter housing 130. The filter media 140 can include various filter media, such as depth filtration media, surface filtration media, cross-flow filtration media, and carbon filtration media. In operation, the filter media 140 is used to remove contaminants, such as ionic, organic, or particulate, from the water. The filter head 150 is secured to the filter housing 130 through a tight connection that prevents water from leaking in the filter cartridge 110. Some examples of the tight connection are a screw fit, bond, weld, or other fastening mechanism commonly used for sealing components. The filter receiver 120 comprises a filter receiver inlet port 190, a filter receiver outlet port 191, and a lock 192.

Each end of the filter media 140 is secured by a cap that specifies the direction of the fluid being treated by the water filter assembly 100. At one end, the filter media 140 may be secured by an open end cap 170 and at the other end by a closed end cap 180. Each of the open end cap 170 and the closed end cap 180 may be secured to the filter media 140 using any suitable joining technique, such as adhesives, heat welding, spin welding, engageable thread, and any other appropriate means for joining components. In some embodiments, the open end cap 170 and the closed end cap 180 may be constructed of a polymer, such a polypropylene, that has increased strength and rigidity. The filter housing 130 may be constructed from the same polymer as the open end cap 170 and the closed end cap 180 or from a different polymer having an increased elongation percentage or increased stretch. Examples of suitable polymers include modified polypropylene or polyethylene polymers.

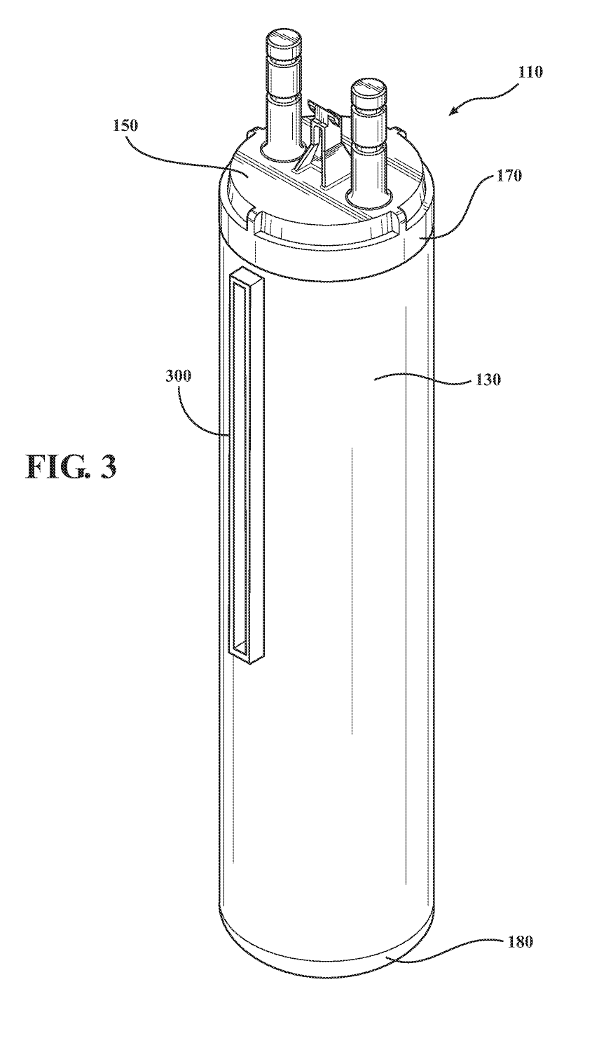

In one embodiment, the filter cartridge 110 may include at least one rib 300 that extends longitudinally down the outer surface of the filter housing 130. Referring to FIG. 3, FIG. 3 shows a perspective view of the filter cartridge 110 with ribs 300 extending at least partially down the outer surface of the filter housing 130. In some examples, the rib 300 serves as a guide for inserting the filter cartridge 110 into portions of the filter receiver 120 to ensure proper alignment. In another embodiment, the rib 300 extends longitudinally the full length of the filter housing 130.

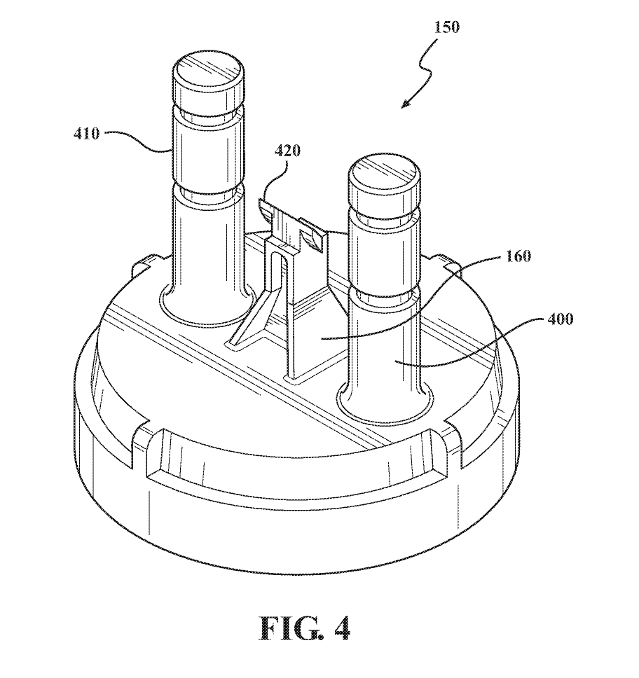

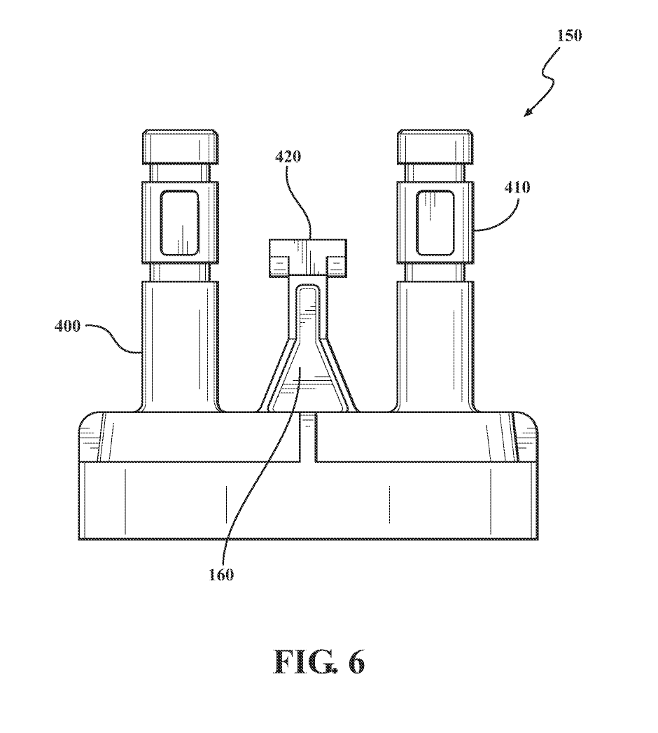

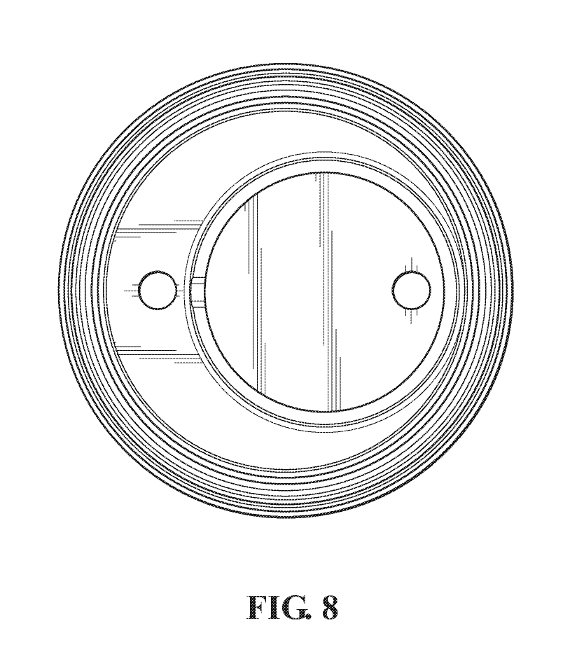

As illustrated in FIGS. 4-8, the filter head 150 comprises an egress or outlet port 400, an ingress or inlet port 410, and a filter key 160. While operating as a filter medium, the outlet port 400 allows fluid to flow out of the filter cartridge 110, while the inlet port 410 allows fluid to flow into the filter cartridge. Specifically, the inlet port 410 directs fluid flow from the center to the outlet port 400. The inlet port 410 and the outlet port 400 are not limited to a specific ingress and egress location and the location of the inlet port 410 and the outlet port 400 may be interchanged on the filter head 150 in some embodiments.

The filter key 160 is securely affixed to the filter head 150 of the filter cartridge 110. The filter key 160 is integral with the filter head 150 as a one piece construction. The filter key 160 may be injection molded, fused, or mechanically bonded (glued, welded, or the like) to the filter head 150. Thus, the filter key 160 is not a separate component that is later attached to the filter head 150 by other techniques, such as press fit, snap fit, friction fit, compression fit, or the like. Without being molded or mechanically bound to the filter head 150, the filter key 160 may easily become dislodged in transit and be separated from the filter cartridge 110. As a result, the filter head 150 would be prevented from connecting to the filter receiver 120.

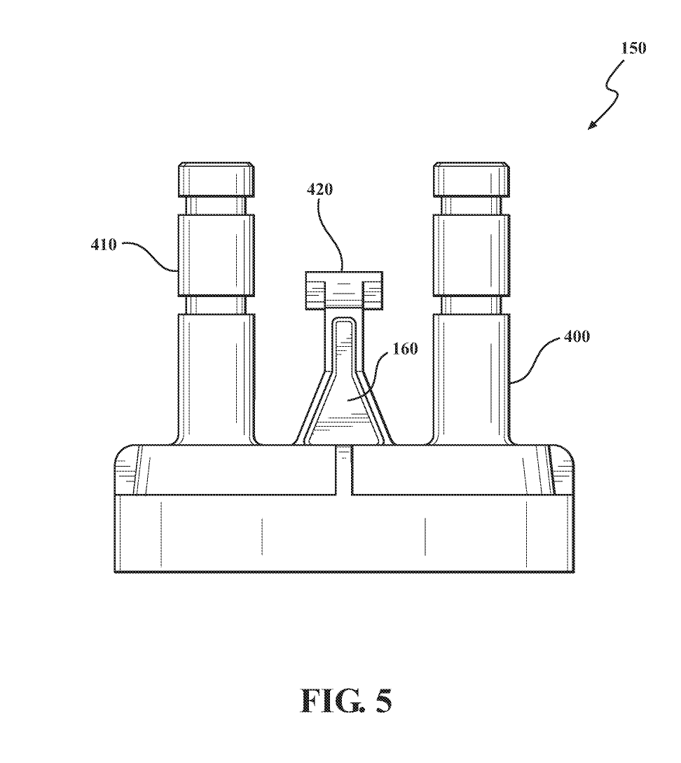

In preferred embodiments, the filter key 160 has exactly one finger 420 extending laterally from the top of the filter head 150. The finger 420 is fabricated from the same material as the filter key 160 and is integrally formed with the filter key 160. In some embodiments, the filter key 160 (not including the finger 420) has a height between about 0.4 and 0.65 inches above the surface of the filter head 150, as illustrated in FIGS. 4 and 5. In these embodiments, the filter key 160 (not including the finger 420) may have a height of about 0.6 inches above the surface of the filter head 150. In these embodiments, the integrated filter key 160 and finger 420 has a height between about 0.7 and 0.85 inches above the surface of the filter head 150. In these embodiments, the integrated filter key 160 and finger 420 may have a height of about 0.8 inches above the surface of the filter head 150.

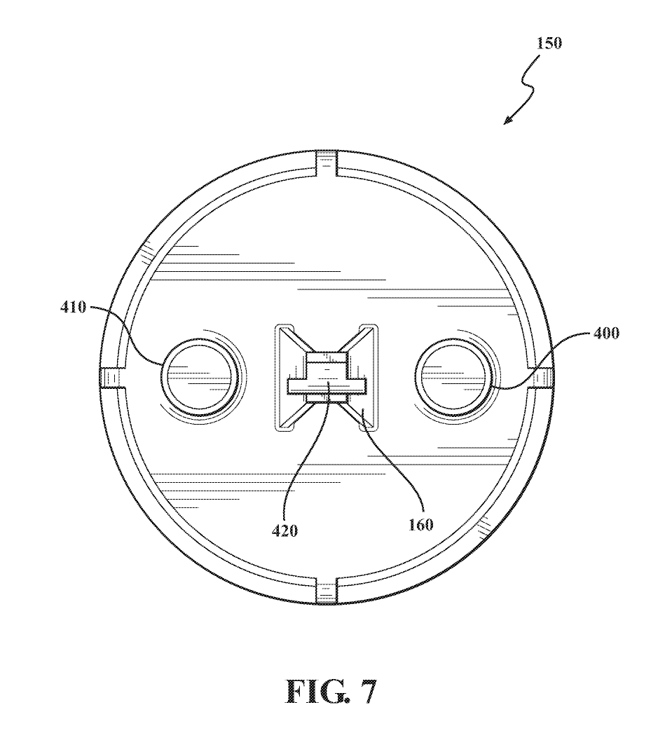

Referring to FIG. 7, FIG. 7 shows a top view the filter head shown in FIG. 4. In exemplary embodiments, the distance between the center of the filter key 160 and the inlet port 410 and the center of the filter key 160 and the outlet port 400 is between about 0.6 and 0.685 inches. In these embodiments, the distance between the center of the filter key 160 and the inlet port 410 and the center of the filter key 160 and the outlet port 400 may be about 0.6 inches. In this embodiment, the filter key 160 is located directly in between the inlet port 410 and the outlet port 400 on the filter head 150. In another exemplary embodiment, the filter key 160 may be located a slightly shorter distance away from either the inlet port 410 or the outlet port 400. However, the filter key 160 is still located between the inlet port 410 and the outlet port 400 on the filter head 150 in order to properly align and interlock with components on the filter receiver 120. The filter key 160 may be associated with various filter cartridges by being specifically color-coded, textured, mirrored, materially modified, or any combination thereof. By having only one finger 420 on the filter key 160, the filter cartridge 110 will be specific for certain types of filter receivers.

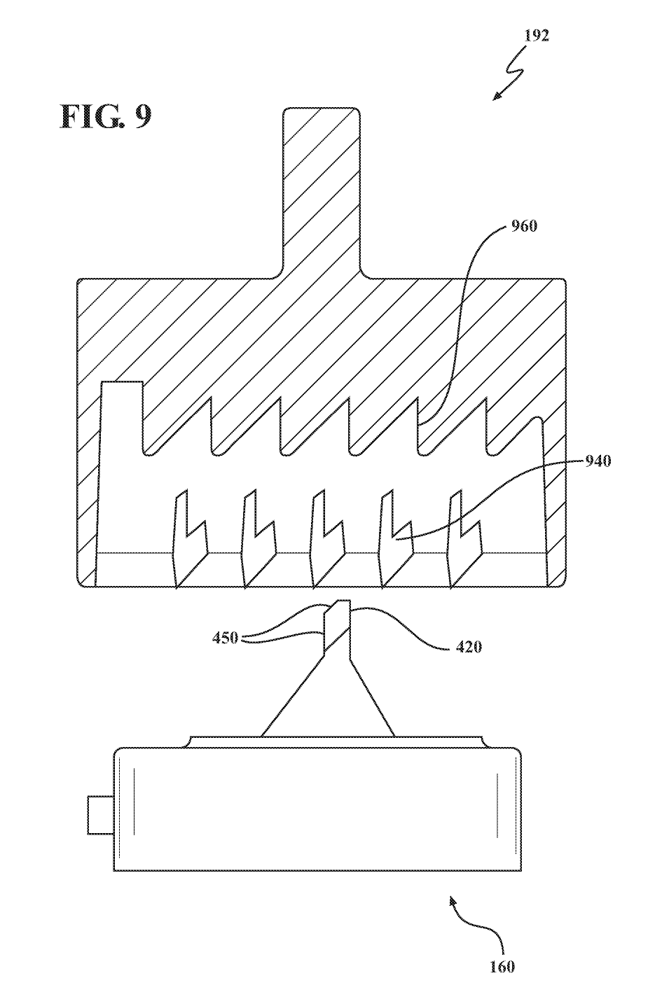

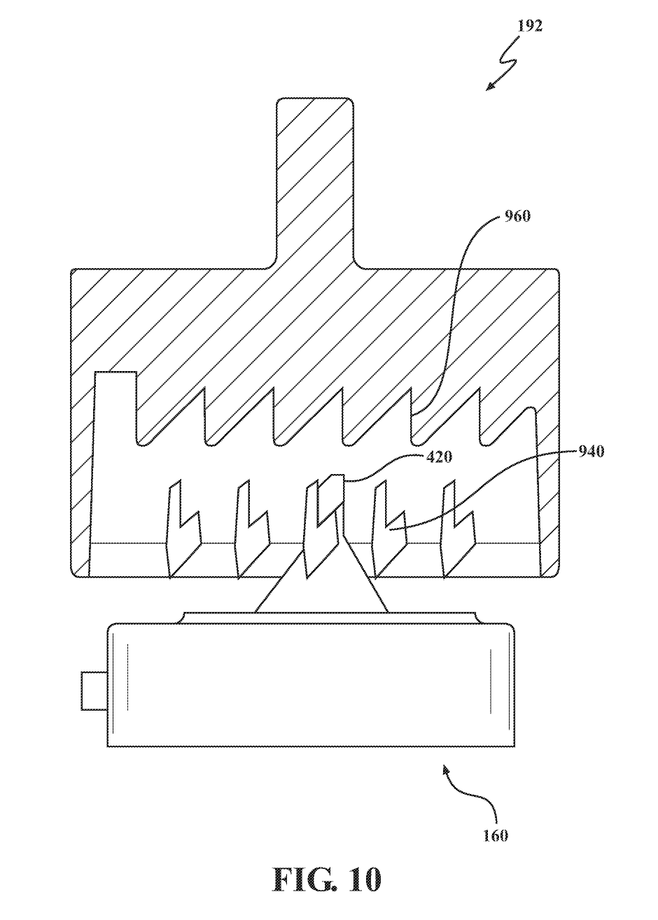

As illustrated in FIGS. 9 and 10, in operation, the filter receiver 120 is operatively connected with the filter cartridge 110 and fluidly connects the filter receiver outlet port 191 with the inlet port 410 of the filter cartridge 110, as well as the filter receiver inlet port 190 with the outlet port 400 of the filter cartridge 110. The fluid source is in fluid communication with the filter receiver 120 and prohibited from flowing when the filter cartridge 110 is removed from the filter receiver 120. The lock 192 comprises at least one hook 940 that specifically aligns with the finger 420 on the filter key 160 during attachment by the filter cartridge 110. The hook 940 is angled such that is able to reciprocally align and interlock with the finger 420. The lock 192 also comprises a row of position stops 960. The position stops 960 prevent the finger 420 from extending any further during insertion into the lock 192 to prevent over insertion of the filter key 160. There is a gap or space between the top most portion of the hook 940 and the bottom most portion of the position stops 960.

Referring to FIG. 10, FIG. 10 is a perspective view of the filter cartridge shown in FIG. 1 engaging with the filter receiver 120 shown in FIG. 9. When the filter key 160 is inserted to mate with the lock 192, the hook 940 comes into slidable contact with the finger 420 as the top portion of the finger 420 slides horizontally until the bottom portion of the finger 420 traverses the hook 940. As this occurs, the top portion of the finger 420 returns to its original position and the filter key 160 aligns or interlocks with the hook 940. This position securely connects the filter key 160 to the lock 192 on the filter receiver 120.

As illustrated in FIGS. 9 and 10, the finger 420 of the filter key 160 has angled sides 950 that slidably contact complementary angled edges on the hook 940 of the lock 192 when mating with the filter receiver 120. In some embodiments, there are two angled sides 950 and each of the angled sides 950 are angled substantially between about 6 and 160 degrees with respect to the finger 420. In the same embodiments, the width of each fully extended angled side 950 is between about 0.24 and 0.41 inches. In an exemplary embodiment, the width of each fully extended angled side 950 may be about 0.3 inches. During insertion of the filter key 160, the angled sides 950 allow the finger 420 to be interlocked with the hook 940. Even though the hook 940 has complementary angled edges, it not necessary that these angled edges be exactly complementary to the angled sides 950 of the finger 420. However, the lock 192 on the filter receiver 120 must be able to receive the filter key 160 when the filter cartridge 110 is inserted into the filter receiver 120.

In some embodiments, such as those illustrated in FIGS. 9 and 10, the finger 420 has a substantially polygon-shaped cross-section to more efficiently and quickly interlock with the hook 940 on the filter receiver 120. In other embodiments, the finger 420 has a substantially boomerang-/stealth-bomber-shaped cross-section, a small substantially circular-shaped cross-section, or a substantially kidney-bean (rounded boomerang) shaped cross-section. The shapes disclosed in these embodiments for the finger 420 make it easier for a user to engage the filter cartridge 110 with the filter receiver 120 by minimizing the amount of surface area on the filter key 160 required to be aligned and interlocked with the filter receiver 120. In order to remove the filter cartridge 110 from the filter receiver 120, a user pushes on the filter cartridge 110, which releases the angled sides 950 on the filter key 160 from the hook 940. This forces the top portion of the finger 420 to slide horizontally until the bottom portion of the finger 420 traverses the hook 940 and the filter cartridge 110 can be readily removed from the filter receiver 120.

The engagement between the filter cartridge 110 and the filter receiver 120 is much easier when the user needs to only align one finger 420 on the filter key 160, as opposed to a plurality of fingers. The greater the number of fingers on a filter key, the more difficult it is for the user to precisely align each of the fingers into the lock 192 on the filter receiver 120 when inserting the filter cartridge 110. Thus, by using only one finger, the risk of preventing a positive lock with the filter receiver 120 due to the problems with the other fingers is greatly reduced. This becomes particularly difficult if the lock 192 is not centrally aligned or presented as a slight angle.

As illustrated in FIGS. 4-8, the filter key 160 may be molded into the filter head 150 as a part of a single component when the filter key 160 only includes the single finger 420. As a result, the filter key 160 is not a separate component that can easily fall off from the filter cartridge 110. A loss of the filter key 160 will most certainly prevent the filter cartridge 110 from attaching to the filter receiver 120. A filter key having a plurality of fingers cannot be molded into the filter head 150 and must be a separate component. The filter cartridge 110 described above does not comprise any additional bosses or supporting members on the filter key 160. In addition, there are no additional attachment structures, besides those described above, on the filter head 150.

It will, of course, be understood that, although particular embodiments have just been described, the claimed subject matter is not limited in scope to a particular embodiment or implementation. Likewise, an embodiment may be implemented in any combination of compositions of matter, apparatuses, methods or products made by a process, for example. Components and features from different filter cartridges may be combined or modified as suitable for a particular application. Accordingly, other implementations are within the scope of the following claims.

1. A water filter assembly comprising:
a filter cartridge comprising:
a filter housing for enclosing a filter media;
a filter head securely connected to the filter housing, the filter head comprising:
an inlet port;
an outlet port; and
a filter key integrally formed on the filter head between the inlet port and the outlet port, the filter key consisting of one finger extending laterally from the top of the filter head, wherein the finger is integrally formed on the filter key and the finger comprises angled sides configured for attachment to a filter receiver.

2. The water filter assembly of claim 1, wherein the filter key is integrally formed on the filter head by molding, fusing, or mechanically bonding.

3. The water filter assembly of claim 1, wherein the finger has a substantially polygon-shaped cross-section.

4. The water filter assembly of claim 1, wherein the finger has a substantially circular-shaped cross-section.

5. The water filter assembly of claim 1, wherein the finger has a substantially boomerang-shaped cross-section.

6. The water filter assembly of claim 1, wherein the distance between the center of the filter key and the inlet port is identical to the distance between the center of the filter key and the outlet port.

7. The water filter assembly of claim 6, wherein the distance between the center of the filter key and the inlet port is between about 0.6 and 0.685 inches and the distance between the center of the filter key and outlet port is between about 0.6 and 0.685 inches.

8. The water filter assembly of claim 1, wherein the filter cartridge comprises at least one rib extending longitudinally down the outer surface of the filter housing.

9. The water filter assembly of claim 1, wherein the angle of each of the angled sides of the finger is between about 6 and 160 degrees with respect to the finger.

10. The water filter assembly of claim 1, further comprising a filter receiver configured for specifically receiving and securely connecting the finger upon insertion of the filter cartridge into the filter receiver.

11. The water assembly of claim 10, wherein the filter receiver comprises a filter receiver inlet port, a filter receiver outlet port, and a lock.

12. The water assembly of claim 11, wherein the lock comprises at least one hook including angled edges configured for slidably interlocking the angled sides of the finger.

13. A water filter assembly comprising:
a filter cartridge comprising:
a filter housing for enclosing a filter media;
a filter head securely connected to the filter housing, the filter head comprising:
an inlet port;
an outlet port; and
a filter key integrally formed on the filter head between the inlet port and the outlet port, the filter key consisting of one finger extending laterally from the top of the filter head, wherein the finger is integrally formed on the filter key and the finger comprises angled sides; and
a filter receiver configured for specifically receiving and securely connecting the finger upon insertion of the filter cartridge into the filter receiver, wherein the filter receiver comprises:
a filter receiver inlet port;
a filter receiver outlet port; and
a lock.

14. The water filter assembly of claim 13, wherein the filter key is integrally formed on the filter head by molding, fusing, or mechanically bonding.

15. The water filter assembly of claim 13, wherein the finger has a substantially polygon-shaped cross-section.

16. The water filter assembly of claim 13, wherein the finger has a substantially circular-shaped cross-section.

17. The water filter assembly of claim 13, wherein the finger has a substantially boomerang-shaped cross-section.

18. The water filter assembly of claim 13, wherein the distance between the center of the filter key and the inlet port is identical to the distance between the center of the filter key and the outlet port.

19. The water filter assembly of claim 13, wherein the angle of each of the angled sides of the finger is between about 6 and 160 degrees with respect to the finger.

20. The water assembly of claim 13, wherein the lock comprises a hook including angled edges configured for slidably interlocking the angled sides of the finger.
